(19) United States
(12) Patent Application Publication
(10) Pub. No.: US 2026/0307009 A1
(43) Pub. Date: Oct. 8, 2026

(54) EXHAUST PURIFICATION DEVICE

(71) Applicant: Mazda Motor Corporation, Hiroshima (JP)

(72) Inventors: Yuki MATSUMOTO, Aki-gun (JP); Hiroshi YAMADA, Aki-gun (JP); Hisaya KAWABATA, Aki-gun (JP); Koichiro HARADA, Aki-gun (JP)

(21) Appl. No.: 19/544,695

(22) Filed: Feb. 19, 2026

(30) Foreign Application Priority Data
Mar. 31, 2025 (JP) 2025-058432

(51) Int. Cl. B01D 53/94; B01J 20/18; B01J 23/42; B01J 23/46; B01J 23/63; B01J 29/70; B01J 29/76; B01J 35/00; F01N 3/10; F01N 3/28; F01N 3/32; F01N 13/00

(52) U.S. Cl. CPC B01D 53/9477; B01D 53/944; B01D 53/945; B01J 20/18; B01J 23/42; B01J 23/464; B01J 23/63; B01J 29/7007; B01J 29/763; B01J 35/19; F01N 3/101; F01N 3/2803; F01N 3/32; F01N 13/009; B01D 2253/108; B01D 2255/1021; B01D 2255/1023; B01D 2255/1025; B01D 2255/908; B01D 2255/911; B01D 2255/912; B01D 2257/404; B01D 2257/406; B01D 2257/502; B01D 2257/702; B01D 2258/01; F01N 2370/04

(57) ABSTRACT

An exhaust purification device includes: a first catalyst arranged in an exhaust passage of an engine and containing a three-way catalyst; a second catalyst arranged on a downstream side of the first catalyst and containing an NH₃ adsorbent; a third catalyst arranged on the downstream side of the second catalyst and containing an HC adsorbent; a fourth catalyst arranged on the downstream side of the third catalyst and containing an oxidation catalyst and an oxygen storage/release material; and a secondary air supply device that supplies secondary air between the first catalyst and the second catalyst. The NH₃ adsorbent includes a zeolite having a pore structure of an oxygen ring of less than 10 members, and the HC adsorbent includes a zeolite having a pore structure of an oxygen ring of 10 members or more.

### CROSS-REFERENCE TO RELATED APPLICATION

This application claims priority to Japanese Patent Application No. 2025-058432 filed on Mar. 31, 2025, the entire disclosure of which is incorporated by reference herein.

### BACKGROUND

The present disclosure relates to an exhaust purification device.

A three-way catalyst is known as a catalyst for efficiently purifying HC hydrocarbon (HC), carbon monoxide (CO), nitrogen oxides (NOX), and the like contained in exhaust of an engine. When the air-fuel ratio becomes rich in a cold condition, the amount of NH₃ generated increases due to reactions in the three-way catalyst, such as the NO—CO—H₂O reaction and the NO—H₂ reaction. In view of this, an NH₃ adsorbent is arranged in an exhaust passage as one technique to reduce NH₃ emission. The NH₃ adsorbed by the NH₃ adsorbent is desorbed as the temperature of the NH₃ adsorbent rises, and is oxidized by, for example, a downstream catalyst.

For example, Japanese Unexamined Patent Publication No. 2023-54381 discloses a technology in which a catalyst having a catalytic layer containing an OSC material stacked on an NH₃ adsorption layer containing zeolite as an NH₃ adsorbent is arranged in an exhaust passage. According to this technology, even in a rich region having a low oxygen concentration up to a stoichiometric region, the structural degradation of zeolite can be suppressed by supplying oxygen from the OSC material to the NH₃ adsorption layer, and the NH₃ purification performance can be maintained even after durability testing.

### SUMMARY

Meanwhile, exhaust contains harmful components other than NH₃, and it is necessary to enhance the purification performance of the exhaust purification device for purifying various harmful components including NH₃.

It is therefore an object of the present disclosure to provide an exhaust purification device that is excellent in NH₃ purification performance and in purification performance for other components such as HC.

To address the challenge, an aspect of an exhaust purification device disclosed herein includes: a first catalyst arranged in an exhaust passage of an engine and containing a three-way catalyst; a second catalyst arranged on a downstream side of the first catalyst in the exhaust passage and containing an NH₃ adsorbent; a third catalyst arranged on a downstream side of the second catalyst in the exhaust passage and containing an HC adsorbent; a fourth catalyst arranged on a downstream side of the third catalyst in the exhaust passage and containing an oxidation catalyst and an oxygen storage/release material; and a secondary air supply device configured to supply secondary air between the first catalyst and the second catalyst in the exhaust passage, the NH₃ adsorbent includes a zeolite having a pore structure of an oxygen ring of less than 10 members, and the HC adsorbent includes a zeolite having a pore structure of an oxygen ring of 10 members or more.

According to this configuration, the NH₃ generated in the three-way catalyst under the rich atmosphere in the cold condition is adsorbed by the NH₃ adsorbent arranged on the downstream side. Since the NH₃ adsorbent of this configuration has a low HC adsorption performance, HC contained in the exhaust passes through the second catalyst and is adsorbed by the third catalyst containing the HC adsorbent. Since the NH₃ adsorbent is arranged on the upstream side, its temperature rises earlier than the HC adsorbent. Therefore, NH₃ begins to desorb before HC. When the NH₃ is desorbed, the oxidation reaction of the NH₃ proceeds in the fourth catalyst on the downstream side under the supply of the secondary air, causing generation of oxidation heat. In this way, the temperature of the fourth catalyst can be raised earlier. After that, when the temperature of the HC adsorbent rises, so that the HC is desorbed, the oxidation of the HC having a higher oxidation temperature than that of the NH₃ can be promoted under the supply of the secondary air because the temperature of the fourth catalyst has been raised.

The zeolite having the pore structure of an oxygen ring of less than 10 members is preferably a small pore zeolite having a pore structure of an 8-membered oxygen ring.

Such a small-pore zeolite not only exhibit excellent NH₃ adsorption performance but also has low HC adsorption performance, enabling NH₃ to be selectively adsorbed.

The small-pore zeolite is preferably a CHA-type zeolite containing Cu.

The zeolite having the pore structure of an oxygen ring of 10 members or more is preferably a large pore zeolite having a pore structure of a 12-membered oxygen ring.

Such a large-pore zeolite has excellent HC adsorption performance and can therefore adsorb HC in exhaust. Further, since the second catalyst is arranged on an upstream side of the third catalyst, NH₃ in the exhaust is adsorbed by the second catalyst, and a decrease in the HC adsorption performance due to adsorption of NH₃ by the third catalyst can also be suppressed.

Note that the large-pore zeolite is preferably a BEA-type zeolite.

The configuration may be adapted so that the secondary air is supplied when the temperature of the first catalyst is equal to or lower than a predetermined temperature.

According to this configuration, by introducing secondary air while the catalyst temperature is relatively low, the shortage of oxygen necessary for oxidation of NH₃ and HC in the fourth catalyst can be compensated, thereby promoting the oxidation reaction in the fourth catalyst.

The secondary air supply amount may also be configured to periodically vary.

The fourth catalyst, which contains the oxidation catalyst and an oxygen storage/release material (OSC material), generates adsorption heat through the adsorption of O₂ by the OSC material when the air-fuel ratio of the exhaust is leaner than the stoichiometric air-fuel ratio. Further, the fourth catalyst promotes oxidation reactions of NH₃, HC, CO, and the like, by the oxidation catalyst using the adsorbed O₂ when the air-fuel ratio of the exhaust is stoichiometric or rich (collectively referred to as “non-lean”), thereby generating oxidation heat. In this way, the fourth catalyst repeats the adsorption reaction and the oxidation reaction depending on the lean state and the non-lean state. If the secondary air is steadily supplied, the exhaust may remain lean depending on the air-fuel ratio of the exhaust before the secondary air supply. Thus, the cycle of the lean state and the non-lean state is not generated, and the catalyst temperature may decrease, reducing the activity of the catalyst.

According to the configuration, by periodically varying the secondary air supply amount, the air-fuel ratio of the exhaust can be varied between a lean state and a non-lean state. Thus, a cycle of adsorption heat and oxidation heat is generated, allowing for the maintenance of a high catalyst temperature and the promotion of the catalytic activity.

The fourth catalyst preferably contains, as the oxidation catalyst, a noble metal catalyst supported on the oxygen storage/release material.

According to the configuration, O₂ is adsorbed by the OSC material in a lean atmosphere, which suppresses a decrease in catalytic activity caused by oxidization of the noble metal catalyst when exposed to O₂. Further, in a non-lean atmosphere, the shortage of O₂ required for the oxidation of harmful components such as NH₃, HC, and CO can be compensated by the release of O₂ from the OSC material, and the oxidation of the harmful components can be promoted in the presence of the noble metal catalyst.

The first catalyst may be configured to contain Pt.

According to this configuration, generation of NH₃ in the first catalyst can be promoted, while the performance of the three-way catalyst of the first catalyst is ensured. Thus, the amount of oxidation heat generated in the fourth catalyst is increased, further promoting early temperature rise of the fourth catalyst, which is advantageous in enhancing purification performance of the fourth catalyst.

The configuration may be adapted so that the Pt is arranged in a region of the first catalyst on the downstream end side.

By arranging Pt in a region of the first catalyst on the downstream end side, the purification performance of the three-way catalyst can be sufficiently ensured on the upstream end side of the first catalyst. Further, NH₃ can be proactively generated in the area on the downstream end side of the first catalyst, which is advantageous in improving the purification performance of the fourth catalyst.

The configuration may be adapted so that: the three-way catalyst contains the Pt, Rh, and Pd as noble metal catalysts; a region of the first catalyst on the upstream end side has higher concentrations of the Rh and Pd than the concentration of the Pt, and a region of the first catalyst on the downstream end side has higher concentration of the Pt than the concentrations of the Rh and Pd.

By making the region of the first catalyst on the upstream end side Rh- and Pd-rich, the purification performance of the three-way catalyst can be sufficiently ensured in the upstream end side of the first catalyst. Further, by making the region of the first catalyst on the downstream end side Pt-rich, NH₃ can be proactively generated in that region, which is advantageous in improving the purification performance of the fourth catalyst.

As described above, according to the present disclosure, it is possible to provide an exhaust purification device that is excellent in NH₃ purification performance and in purification performance for other components such as HC.

### BRIEF DESCRIPTION OF THE DRAWINGS

FIG. 1 is a schematic view of an example of an engine system to which an exhaust purification device is applied.

FIG. 2 is a block diagram showing an example of a control system for the engine system to which the exhaust purification device is applied.

FIG. 3 is a flowchart illustrating an example of a control method for the engine system to which the exhaust purification device is applied.

FIG. 4 is a schematic view for explaining the periodicity of a secondary air supply amount and the oxygen concentration of exhaust after secondary air supply.

FIG. 5 is a graph showing NH₃ and HC adsorption performances of Cu-ion-exchanged CHA-type zeolite of Experimental Example A.

FIG. 6 is a graph showing NH₃ and HC adsorption performances of BEA-type zeolite of Experimental Example A.

FIG. 7 is a view for explaining a method of evaluating Experimental Example B.

FIG. 8 is a graph showing a comparison between the gas temperature at inlet and the catalyst center gas temperature of a fourth catalyst of Experimental Example B.

FIG. 9 is an enlarged graph of a broken-line elliptical portion in FIG. 8.

FIG. 10 is a graph showing T50 when the frequency of secondary air is fixed at a predetermined value and the maximum oxygen concentration is varied.

FIG. 11 is a graph showing T50 when the frequency of secondary air is fixed at a predetermined value and the maximum oxygen concentration is varied.

FIG. 12 is a graph showing T50 when the maximum oxygen concentration of secondary air is fixed at a predetermined value and the frequency is varied.

FIG. 13 is a graph showing T50 when the maximum oxygen concentration of secondary air is fixed at a predetermined value and the frequency is varied.

FIG. 14 is a schematic view illustrating another example of an engine system to which an exhaust purification device is applied.

FIG. 15 is a schematic view illustrating another example of an engine system to which an exhaust purification device is applied.

FIG. 16 is a graph showing the difference in NH₃ generation amount between the case where the rear portion of the first catalyst contains Pt in Experimental Example D and the case where it is not.

### DETAILED DESCRIPTION

Embodiments of the present disclosure will now be described in detail with reference to the drawings. The following description of a preferred embodiment is merely an example in nature, and is not intended to limit the scope, applications or use of the present disclosure.

### First Embodiment

### <Outline of Engine System>

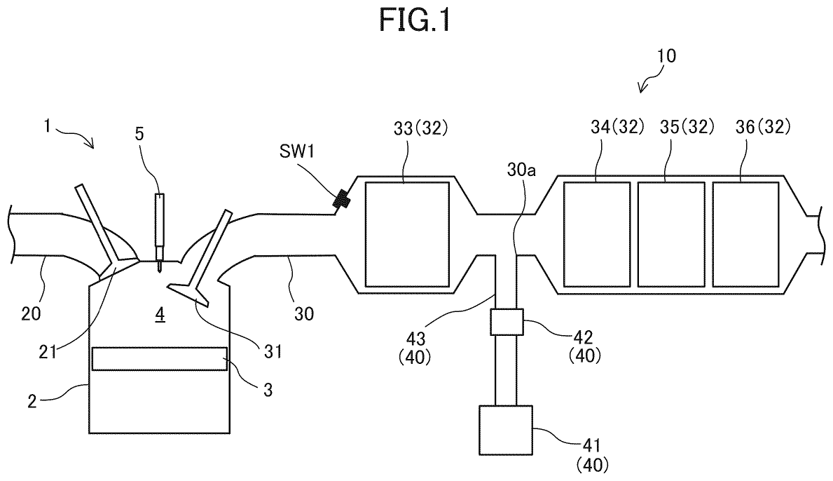

As shown in FIG. 1, an engine system to which an exhaust purification device 10 of the present disclosure is applied includes an engine 1 mounted on a vehicle such as a motor vehicle. The engine 1 of FIG. 1 is a gasoline engine. The exhaust purification device 10 according to the present disclosure is also applicable to an engine system equipped with a diesel engine.

The engine 1 has a cylinder 2 and a piston 3 inserted into the cylinder 2. A combustion chamber 4 is defined by an inner wall of the cylinder 2, a crown surface of the piston 3, and the like. Combustion of an air-fuel mixture in the combustion chamber 4 enables the piston 3 to reciprocate, where an intake stroke, a compression stroke, an expansion stroke, and an exhaust stroke are repeated in the cylinder 2. The engine 1 includes a fuel injection valve 5 for supplying fuel to the combustion chamber 4, and includes an intake passage 20 and an exhaust passage 30 both connected to the combustion chamber 4. The air supplied from the intake passage 20 is introduced into the combustion chamber 4 by an intake valve 21. The exhaust generated by the combustion of the air-fuel mixture in the combustion chamber 4 is discharged to the exhaust passage 30 through an exhaust valve 31.

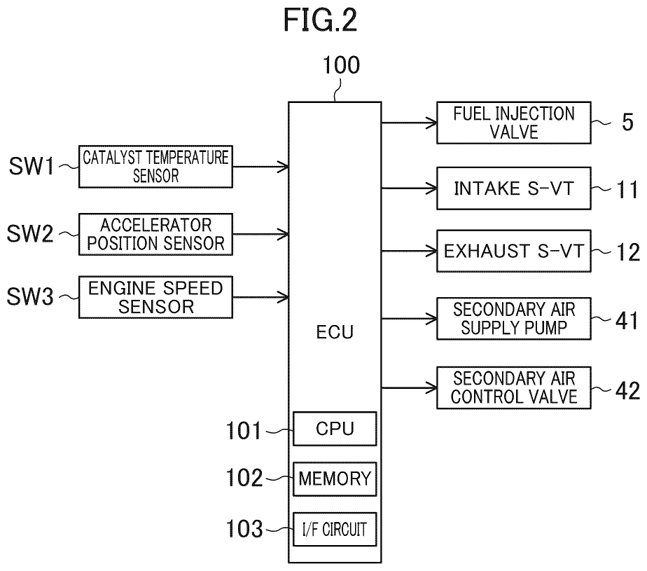

Opening and closing of the intake valve 21 and the exhaust valve 31 are controlled by a valve controller. The valve controller controls opening and closing of the intake valve 21 or the exhaust valve 31, thereby adjusting the amounts of air and burned gas introduced into the cylinder 2. The valve controller is a variable valve mechanism for making the valve timing and/or the valve lift variable, and includes an electric or hydraulic intake sequential-valve timing (S-VT) 11 and an electric or hydraulic exhaust S-VT 12, for example, as shown in FIG. 2. The intake S-VT 11 and the exhaust S-VT 12 continuously vary the rotational phase of an intake camshaft and the rotational phase of an exhaust camshaft, respectively, within a predetermined angular range.

Note that, in this specification, the upstream side and the downstream side of the exhaust passage 30 in the exhaust flow direction will sometimes be referred to simply as the “upstream side” and the “downstream side,” respectively.

### <Exhaust Purification Device>

The exhaust purification device 10 is disposed on the downstream side of the exhaust passage 30. The exhaust purification device 10 includes a catalyst device 32 that purifies the exhaust, and a secondary air supply device 40 that supplies secondary air.

### [Catalyst Device]

The catalyst device 32 includes a first catalyst 33, a second catalyst 34, and a third catalyst 35, and a fourth catalyst 36, which are arranged in this order from the upstream side in the exhaust passage 30.

### —First Catalyst—

The first catalyst 33 includes a three-way catalyst having a function of purifying HC, CO, and NOx. The three-way catalyst is activated at a predetermined temperature or higher, reduces and purifies NOx, and oxidizes and purifies HC and CO. As a result, the amount of HC, CO, and NOx emitted on the downstream side of the first catalyst 33 can be effectively reduced.

In the three-way catalyst, the formation of NH₃ is promoted under a rich atmosphere due to factors such as a decrease in oxygen concentration and an increase in HC and CO concentrations, for example by reactions such as the reaction of NO with hydrogen in the system shown in the following formula (1).

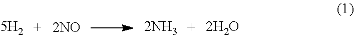

The amount of NH₃ emitted outside the system needs to be reduced as it is a kind of harmful component; however, from the viewpoint that the amounts of other harmful components emitted also need to be reduced at the same time, there is room for improvement in the configuration of the exhaust purification device 10.

In the present configuration, the configuration of the catalysts in the exhaust purification device 10 includes, in this order from the upstream side, a three-way catalyst (first catalyst 33), an NH₃ adsorbent (second catalyst 34), an HC adsorbent (third catalyst 35), and a fourth catalyst 36 containing an oxidation catalyst and an OSC material. Thus, the NH₃ generated in the three-way catalyst of the first catalyst 33 under the rich atmosphere under cold condition is adsorbed by the NH₃ adsorbent of the second catalyst 34 arranged on the downstream side. Since the NH₃ adsorbent of the second catalyst 34 has low HC adsorption performance as described later, the HC contained in the exhaust passes through the second catalyst 34 and is adsorbed by the HC adsorbent of the third catalyst 35.

When the exhaust temperature rises according to the operating state of the engine, the temperature of the NH₃ adsorbent arranged on the upstream side rises earlier than the HC adsorbent, causing the NH₃ to start desorbing earlier than the HC. When the NH₃ is desorbed, the oxidation reaction of the NH₃ proceeds in the fourth catalyst 36 on the downstream side under the supply of the secondary air described later, causing generation of oxidation heat. In this way, the oxidation reaction of the NH₃ proceeds earlier than that of the HC, so that the temperature of the fourth catalyst 36 can be raised earlier. When the exhaust temperature further rises and the temperature of the HC adsorbent rises, causing the HC adsorbent to desorb, the oxidation of the HC having a higher oxidation temperature than that of the NH₃ can be promoted under the supply of the secondary air because the temperature of the fourth catalyst 36 has been raised.

A preferable catalyst used as the three-way catalyst contained in the first catalyst 33 is a catalyst in which a noble metal catalyst such as Rh (rhodium), Pd (palladium), or Pt (platinum) is supported on or doped into a support material such as an oxide.

Examples of the support material include an OSC material, a Ce-free Zr-based composite oxide, and alumina.

The three-way catalyst preferably contains an OSC material as a support material. The OSC material stores oxygen in a lean atmosphere with high oxygen concentration in the exhaust gas, and releases active oxygen in a stoichiometric or rich atmosphere with low oxygen concentration in the exhaust gas. The noble metal catalyst has an increased NOx purification rate in a rich atmosphere, whereas in a lean atmosphere, the noble metal catalyst is exposed to oxygen, so that the catalytic metal is oxidized to decrease the activity, and the NOx purification rate is decreased. With the OSC material, the OSC material adsorbs oxygen in a lean atmosphere, so that oxidation of the catalytic metal is suppressed and a decrease in the NOx purification rate can be suppressed. Further, the OSC material adsorbs oxygen, thereby generating adsorption heat. The adsorption heat raises the temperature of the catalyst, which is advantageous for the purification of the exhaust. Further, in a stoichiometric or rich atmosphere, oxygen adsorbed by the OSC material is desorbed and can be used for oxidation of HC and CO, which is advantageous for purification of these. In other words, in a three-way catalyst, the action of the OSC material makes it easier to form a stoichiometric atmosphere where the exhaust purification performance can be easily exhibited, and even if the air-fuel ratio of the exhaust varies slightly from stoichiometric, HC, CO, and NOx are efficiently purified (the A/F window is expanded).

Examples of the OSC material include, but are not limited to, oxides containing Ce, such as ceria, Ce-based composite oxides, and CeZr-based composite oxides. The oxides containing Ce store oxygen in the exhaust and releases the oxygen as active oxygen by the reversible progress of a reaction accompanied by a change in the valence of Ce. As the CeZr-based composite oxide, for example, a composite oxide containing a metal element other than Ce such as Nd, Y, or La, preferably a rare earth element, may be used.

In addition, the Ce-free Zr-based composite oxide, which has high ion conductivity, takes oxygen inside from the surroundings through an oxygen exchange reaction and releases active oxygen with no change in the valence of metal ions, allowing the release of oxygen in a lower rate as compared with the Ce-based OSC material. Thus, for example, the Rh-supporting Ce-free Zr-based composite oxide can maintain Rh in an appropriately (not excessively) oxidized state or reduced state even immediately after the exhaust gas atmosphere is switched from lean to rich, and can effectively purify NOx. As the Ce-free Zr-based composite oxide, for example, a composite oxide containing a metal element other than Ce, such as Nd, Y, or La, preferably a rare earth element, may be used.

The first catalyst 33 may also contain a promoter. Examples of such a promoter include OSC materials that do not contain noble metal catalysts, Ce-free Zr-based composite oxides, alumina, and zirconia.

Note that Ce-based OSC material tend to have a decrease in their oxygen storage/release capacity when P poisoning occurs and a compound of Ce and P is formed. Therefore, the first catalyst 33 preferably includes a P poisoning suppressor such as Ba, which captures P in the form of Ba—O—P compounds, from the viewpoint of suppressing P poisoning of the OSC material. A Ba source is not particularly limited, and a generally known substance can be used. Specific examples of the Ba source include barium sulfate, barium nitrate, barium acetate, and Ba₃P₄O₁₃. The first catalyst 33 may contain the Ba either in the form of the substance itself serving as the Ba source, or in the form of being supported on the support material such as alumina.

The first catalyst 33 is formed by providing a catalytic layer on a wall surface of a carrier made of a flow-through-type substrate formed of an inorganic porous material such as cordierite, SiC, Si₃N₄, sialon, or AlTiO₃. The catalytic layer may have a single-layer structure or a multilayer structure. The substrate may be of a wall-flow-type.

The catalytic layer is configured to include the above-described catalyst, a promoter, a binder of an optional component, and the like. As the binder, an alumina binder, a zirconia binder, or the like can be used.

The amount of the catalyst, the promoter, the support material, and the like supported on the substrate is not particularly limited and is appropriately determined according to the purification performance. The supporting amount may be, for example, about 1 g/L to about 10 g/L in terms of metal for the noble metal catalyst, and about 20 g/L to about 300 g/L for other catalytic components such as a promoter and a support material. Further, in the case where a Ba source is included as a P poisoning suppressor, the supporting amount may be about 5 g/L to about 20 g/L in terms of Ba metal. Note that the unit “g/L” means the amount supported per liter of the carrier. Additionally, the content of the binder may be any amount sufficient for layer formation, for example, 5 mass % to 20 mass % of the catalytic layer.

A catalyst temperature sensor SW1 may be arranged near the inlet or outlet of the first catalyst 33. The catalyst temperature sensor SW1 is capable of detecting the temperature of the exhaust passing through the first catalyst 33. From the temperature detected by the catalyst temperature sensor SW1, the temperature of the first catalyst 33 can be estimated.

### —Second Catalyst—

The second catalyst 34 contains an NH₃ adsorbent. The NH₃ adsorbent includes zeolite having a pore structure of an oxygen ring of less than 10 members.

Zeolite is a crystalline aluminosilicate having (SiO₄)⁴⁻ and (AlO₄)⁵⁻, which have a tetrahedral structure, as structural basic units, and in the present specification, crystalline metal aluminophosphates such as crystalline aluminum phosphate and crystalline aluminum silico-phosphate are also included in this concept. Zeolite has a structure in which the above basic units are three-dimensionally connected to each other through oxygen atoms, and has regular small pores, and therefore is used for a molecular sieve or the like. The framework structure of zeolite can be represented by a code defined by the International Zeolite Association (IZA).

As a method for classifying zeolites, a method of expressing the number of oxygen atoms contained in the ring structure is known, and for example, a pore structure of an N-membered oxygen ring means that the pore has a ring structure composed of N basic units.

The zeolite having a pore structure of an oxygen ring of less than 10 members is a zeolite having a relatively small pore size of less than about 5 Å, and has excellent NH₃ adsorption performance having a molecular size of about 2 Å. Examples of such a zeolite include a zeolite having a 6-membered oxygen ring structure, an 8-membered oxygen ring structure, and a 9-membered oxygen ring structure. Specific examples of such a zeolite includes CHA, ANA, ERI, GIS, KFI, LTA, NAT, PAU, YUG, DDR, AEI, AFX, LFI, SFW, MFI, and the like, as indicated by the IZA code.

The zeolite contained in the NH₃ adsorbent is preferably a small pore zeolite having a pore structure of an 8-membered oxygen ring, such as CHA, ANA, ERI, GIS, KFI, LTA, NAT, PAU, YUG, or DDR, and more preferably a CHA-type zeolite. The small pore zeolite with an 8-membered oxygen ring structure has a pore size of about 4 Å, and while it has excellent NH₃ adsorption performance, its adsorption performance for relatively large HC (such as n-octane) having a molecular size exceeding about 4 Å is low, allowing it to selectively adsorb NH₃.

The zeolite contained in the NH₃ adsorbent is preferably ion-exchanged zeolite. Examples of such an ion-exchanged element include, but are not limited to, K, Ca, Na, Cu, Fe, Ag, and P, and Cu is preferable. The concentration of the ion-exchanged element contained in the zeolite is not limited, but may be, for example, 2 mass % to 4 mass %. The chemical adsorption strength (solid acid sites) of the zeolite is enhanced by the ion exchange, and the zeolite works advantageously for the adsorption of NH₃.

The Si/Al ratio of the zeolite contained in the NH₃ adsorbent is not limited, but may be, for example, 20 to 40. The lower the Si/Al ratio, the higher the relative amount of Al, which increase the number of solid acid sites, resulting in a higher adsorption amount of NH₃.

As the NH₃ adsorbent, one of the above-mentioned zeolites may be used alone, or two or more of them may be used in combination.

The second catalyst 34 can be configured by forming a catalytic layer containing an NH₃ adsorbent on a wall surface of a carrier made of a substrate formed from the aforementioned inorganic porous materials, similar to the first catalyst 33.

The second catalyst 34 may also include the above-described noble metal catalyst, promoter, binder, and the like, in addition to the NH₃ adsorbent. The second catalyst 34 may include a catalyst material in which a noble metal catalyst is supported on or doped into the support mentioned above.

The amount of the catalytic layer supported on the substrate is not particularly limited and is appropriately determined according to the adsorption performance and purification performance. In particular, for example, the supporting amount of the NH₃ adsorbent may be about 20 g/L to about 300 g/L. The amounts of the other components supported may be similar to those of the first catalyst 33.

The second catalyst 34 adsorbs NH₃ at a low catalyst temperature of less than about 200° C., and starts to desorb NH₃ at a catalyst temperature of about 200° C. or more.

### —Third Catalyst—

The third catalyst 35 contains an HC adsorbent. The HC adsorbent includes a zeolite having a pore structure of an oxygen ring of 10 members or more.

The zeolite having a pore structure of an oxygen ring of 10 members or more is a zeolite having a pore size of about 5 Å or more, for example having pores ranging from about 5 Å to about 10 Å, and has excellent adsorption performance for HC, preferably for HC having 6 or more carbon atoms. Examples of such zeolites include, for example, a zeolite having a 10-membered oxygen ring (medium pore zeolite) and a 12-membered oxygen ring structure (large pore zeolite). Specific examples of such a zeolite includes AEL, EUO, FER, HEUMEL, MFI, NES, TON, WEI, AFI, ATO, BEA, CON, FAU, GME, LTL, MOR, MTW, OFF, and the like, as indicated by the IZA code.

The zeolite contained in the HC adsorbent is preferably a large pore zeolite having a pore structure of a 12-membered oxygen ring, such as AFI, ATO, BEA, CON, FAU, GME, LTL, MOR, MTW, or OFF, and more preferably a BEA-type zeolite.

Such a large-pore zeolite has excellent HC adsorption performance and can therefore adsorb HC in exhaust. In this configuration, since the second catalyst 34 is arranged on the upstream side of the third catalyst 35, NH₃ in the exhaust is adsorbed by the second catalyst 34, and a decrease in the HC adsorption performance due to adsorption of NH₃ by the third catalyst 35 can also be suppressed.

The Si/Al ratio of the zeolite contained in the HC adsorbent is not limited, but may be, for example, 20 or more, and may be from 20 to 1000. The higher the Si/Al ratio, the more advantageous it is for the adsorption of HC.

As the HC adsorbent, one of the above-mentioned zeolites may be used alone, or two or more of them may be used in combination.

The third catalyst 35 can be configured by forming a catalytic layer containing an HC adsorbent on a wall surface of a carrier made of a substrate formed from the aforementioned inorganic porous materials, similar to the first catalyst 33.

The third catalyst 35 may also include the above-described noble metal catalyst, promoter, binder, and the like, in addition to the HC adsorbent. The third catalyst 35 may include a catalyst material in which a noble metal catalyst is supported on or doped into the support mentioned above.

The amount of the catalytic layer supported on the substrate is not particularly limited and is appropriately determined according to the adsorption performance and purification performance. In particular, for example, the supporting amount of the HC adsorbent may be about 20 g/L to 300 g/L. The amounts of the other components supported may be similar to those of the first catalyst 33.

The third catalyst 35 adsorbs HC at a low catalyst temperature of less than about 200° C., and starts to desorb HC at a catalyst temperature of about 200° C. or more.

### —Fourth Catalyst—

The fourth catalyst 36 contains an oxidation catalyst and an OSC material.

The oxidation catalyst is a catalyst for purifying at least NH₃ and HC through oxidation, and is preferably a catalyst for purifying NH₃, HC, CO, and other harmful components through oxidation.

The oxidation catalyst is not particularly limited, and a generally known oxidation catalyst can be used. Examples of the oxidation catalyst include noble metal catalysts such as rhodium (Rh), palladium (Pd), and platinum (Pt). The noble metal catalyst is preferably supported on or doped into the OSC material.

Since O₂ is adsorbed by the OSC material in a lean atmosphere, the noble metal catalyst is kept from being exposed to O₂ and oxidized, thereby suppressing the deterioration of the catalytic activity. Further, in a non-lean atmosphere, the shortage of O₂ required for the oxidation of harmful components such as HC, CO, and NH₃ can be compensated by the release of O₂ from the OSC material, and the oxidation of the harmful components can be promoted in the presence of the noble metal catalyst.

Examples of the OSC material include materials similar to the OSC material contained in the first catalyst 33.

The fourth catalyst 36 can be configured by forming a catalytic layer on a wall surface of a carrier made of a substrate formed from the aforementioned inorganic porous materials, similar to the first catalyst 33.

The fourth catalyst 36 may also contain the above-described promoter, binder, and the like. The amount of the catalytic layer supported on the substrate is not particularly limited and is appropriately determined according to the purification performance. The supporting amount may be, for example, about 1 g/L to about 10 g/L in terms of metal for the noble metal catalyst, and about 20 g/L to about 300 g/L for other catalytic components such as a promoter and a support material. Further, in the case where a Ba source is included as a P poisoning suppressor, the supporting amount may be about 5 g/L to about 20 g/L in terms of Ba metal. Further, the content of the binder may be any amount sufficient for layer formation, for example, 5 mass % to 20 mass % of the catalytic layer.

The fourth catalyst 36 may also have a configuration that includes a three-way catalyst similar to the first catalyst 33, or may have the same configuration as the first catalyst 33.

### [Secondary Air Supply Device]

The secondary air supply device 40 is a device that supplies secondary air to a portion of the exhaust passage 30 between the first catalyst 33 and the second catalyst 34. The secondary air supply device 40 is not particularly limited as long as secondary air can be supplied through the secondary air supply opening 30a on the exhaust passage 30 with an adjustable flow rate, and a generally known secondary air supply device can be used.

Specifically, for example, the secondary air supply device 40 includes a secondary air supply pump 41, a secondary air control valve 42, and a secondary air supply passage 43. The secondary air supply pump 41 is driven by the engine 1, and takes in outside air and feeds the same to the secondary air supply passage 43. The secondary air is not limited to the outside air, and for example, a branch passage may be provided on the downstream side of the catalyst device 32 in the intake passage 20 or the exhaust passage 30, and air supplied from the intake passage 20 or the exhaust passage 30 may be used. The secondary air supply passage 43 is connected to the discharge port of the secondary air supply pump 41 and the secondary air supply opening 30a on the exhaust passage 30. The secondary air supply device 40 may have a surge tank as needed between the secondary air supply pump 41 and the secondary air control valve 42. The secondary air may be supplied through an injector or the like.

As described later, the secondary air supplied to the exhaust passage 30 through the secondary air supply opening 30a is preferably controlled so that the secondary air supply amount periodically varies. In other words, the secondary air preferably has periodicity.

Specifically, for example, the secondary air supply pump 41 and the secondary air control valve 42 are electrically connected to an ECU 100, which will be described later. For example, the amount of secondary air discharged by the secondary air supply pump 41 is adjusted based on output signals from the ECU 100. Further, for example, the opening degree of the secondary air control valve 42 is adjusted based on output signals from the ECU 100. The periodicity of the secondary air can be imparted by the ECU 100 through control of at least one of the secondary air discharge amount of the secondary air supply pump 41 or the opening degree of the secondary air control valve 42.

### <Control System>

Next, an example of the control system of the exhaust purification device 10 will be described with reference to FIG. 2. The engine system according to this embodiment is controlled by the engine control unit (ECT) 100 provided in the vehicle. The ECU 100 is a controller based on a well-known microcomputer, and includes a central processing unit (CPU) 101, a memory 102, and an I/F circuit 103. The CPU 101 executes programs. The memory 102 includes a random access memory (RAM) or a read only memory (ROM), for example, and stores programs and data. The I/F circuit 103 inputs and outputs electric signals. The ECU 100 is an example of a controller.

As shown in FIGS. 1 and 2, various sensors including sensors SW1 to SW3 are electrically connected to the ECU 100. The ECU 100 performs various calculations based on input signals from these sensors. For example, the sensors SW1 to SW3 have the following functions.
Catalyst temperature sensor SW1 that is arranged near the inlet of the first catalyst 33 in the exhaust passage 30 and detects the temperature of the exhaust. The temperature of the exhaust can be estimated as the catalyst temperature. Note that the catalyst temperature sensor SW1 may be arranged near the outlet of the first catalyst 33. Further, the catalyst temperature sensor may be also provided near the inlet of the second catalyst 34 or the outlet of the fourth catalyst 36.
Accelerator position sensor SW2 that is attached to an accelerator pedal mechanism and detects the amount of depression of the accelerator pedal (the accelerator position).
Engine speed sensor SW3 that is attached to the engine 1 and detects the speed of the engine 1.

Although not illustrated in FIGS. 1 and 2, an exhaust sensor that detects the component concentrations of the exhaust, the oxygen concentration, the A/F, and the like may be provided near the inlet or the outlet of each catalyst in the exhaust passage 30.

The ECU 100 determines the operating state of the engine 1 based on the signals from the sensors SW1 to SW3 and the like, and calculates the control amount of each device according to a control logic defined in advance. The control logic is stored in the memory 102. The control logic includes calculating the target amount and/or the control amount using a map stored in the memory 102.

The ECU 100 is electrically connected to devices such as the fuel injection valve 5, the intake S-VT 11, the exhaust S-VT 12, the secondary air supply pump 41, the secondary air control valve 42, and the like. The ECU 100 outputs the electric signal related to the calculated control amount to the fuel injection valve 5, the intake S-VT 11, the exhaust S-VT 12, the secondary air supply pump 41, the secondary air control valve 42, and the like.

### <Control for Catalyst Temperature Decrease>

As a controller of the exhaust purification device 10, the ECU 100 supplies secondary air to activate the catalyst when the catalyst temperature is low. Specifically, the ECU 100 determines whether the temperature detected by the catalyst temperature sensor SW1 is lower than or equal to a predetermined temperature stored in the memory 102. If the temperature is lower than or equal to the predetermined temperature, the ECU 100 outputs control signals to the secondary air supply pump 41, the secondary air control valve 42, and the like, in order to supply secondary air from the secondary air supply passage 43 to the exhaust passage 30. According to this configuration, by introducing secondary air while the catalyst temperature is relatively low, the shortage of oxygen necessary for oxidation of harmful components such as NH₃ and HC in the fourth catalyst 36 can be compensated, thereby promoting the oxidation reaction in the fourth catalyst 36.

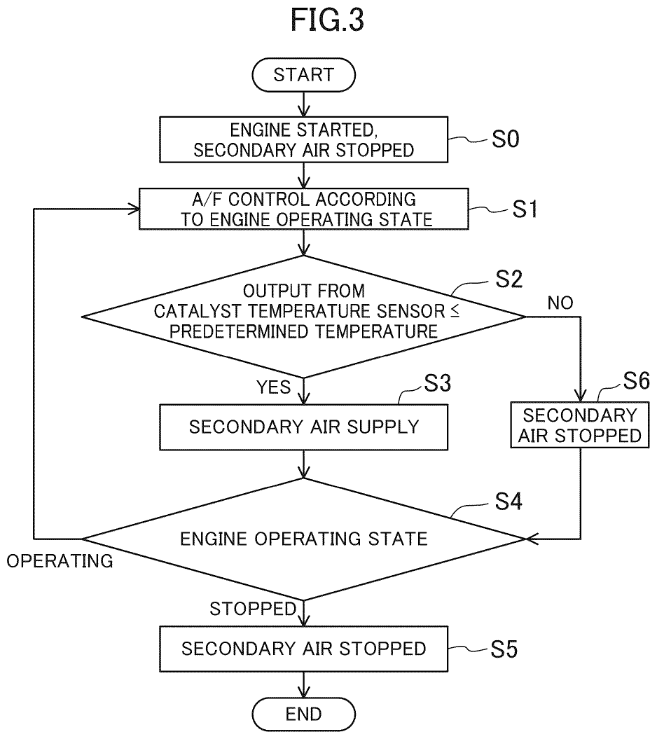

Specifically, an example of control procedure of the exhaust purification device 10 executed by the ECU 100 will be described with reference to FIG. 3.

First, based on an input signal and the like from a driver, the ECU 100 instructs the fuel injection valve 5 to inject fuel into the combustion chamber, and instructs the ignition device to ignite the fuel to start the engine 1 (step S0). The secondary air supply device 40 is stopped at this time.

During the operation of the engine 1, the ECU 100 performs A/F control according to, for example, the operating state of the engine 1 based on information and the like from various sensors (step S1).

In step S2, the ECU 100 determines whether the temperature detected by the catalyst temperature sensor SW1 is lower than or equal to a predetermined temperature stored in the memory 102. If the temperature detected by the catalyst temperature sensor SW1 is lower than or equal to the predetermined temperature (YES in step S2), the ECU 100 proceeds to step S3. If the temperature detected by the catalyst temperature sensor SW1 is not lower than or equal to the predetermined temperature (NO in step S2), and the secondary air is being supplied, the ECU 100 stops the supply of the secondary air (step S6) and proceeds to step S4.

In step S3, the ECU 100 outputs control signals to the secondary air supply pump 41, the secondary air control valve 42, and the like, and supplies the secondary air from the secondary air supply passage 43 to the exhaust passage 30.

In step S4, the ECU 100 reads the information from the sensors, and proceeds to step S5 if the operation of the engine 1 is stopped. The ECU 100 continues to repeat steps S1 to S4 while monitoring various parameters through various sensors during engine operation.

In step S5, if the secondary air is being supplied, the ECU 100 outputs control signals to the secondary air supply pump 41, the secondary air control valve 42, and the like, in order to stop supplying the secondary air to the exhaust passage 30.

By following the flow in FIG. 3, the ECU 100 activates the catalyst by supplying the secondary air when the catalyst temperature drops. This promotes purification of the harmful components in the fourth catalyst 36.

Note that the predetermined temperature in step S2 can be set to a temperature at which the catalyst device 32 begins to exhibit a purification action and the like, and can be set to a specific temperature of, for example, 200° C. or more and 400° C. or less, preferably 250° C. or more and 300° C. or less.

Even when the catalyst temperature is low, the ECU 100 preferably controls the fuel injection valve 5 or the like so that the air-fuel ratio in the combustion chamber 4 becomes slightly richer (λ<1) (e.g., A/F=about 14) than the stoichiometric air-fuel ratio (A/F=14.7) (λ=1). This allows a certain amount of fuel to flow into the first catalyst 33, and thus the catalytic reaction of the first catalyst 33 can continue and the temperature can be kept high. The air-fuel ratio is not limited the above air-fuel ratio, and the stoichiometric air-fuel ratio may be employed.

### <Periodicity of Secondary Air>

As described above, the secondary air supply amount may be configured to vary periodically. When the secondary air having periodicity is supplied, the secondary air is periodically supplied to the second catalyst 34 to the fourth catalyst 36 arranged on the downstream side of the secondary air supply opening 30a.

The fourth catalyst 36, which contains the oxidation catalyst and OSC material, generates adsorption heat through the adsorption of O₂ by the OSC material when the air-fuel ratio of the exhaust is leaner than the stoichiometric air-fuel ratio. Further, the fourth catalyst 36 promotes oxidation reactions of NH₃, HC, CO, and the like, by the oxidation catalyst using the adsorbed O₂ when the air-fuel ratio of the exhaust is non-lean, thereby generating oxidation heat. In this way, the fourth catalyst 36 repeats the adsorption reaction and the oxidation reaction depending on the lean state and the non-lean state. By periodically varying the secondary air supply amount, the air-fuel ratio of the exhaust can be varied between a lean state and a non-lean state. Thus, in the fourth catalyst 36, a cycle of adsorption heat and oxidation heat is generated, allowing for the maintenance of a high catalyst temperature and the promotion of the catalytic activity.

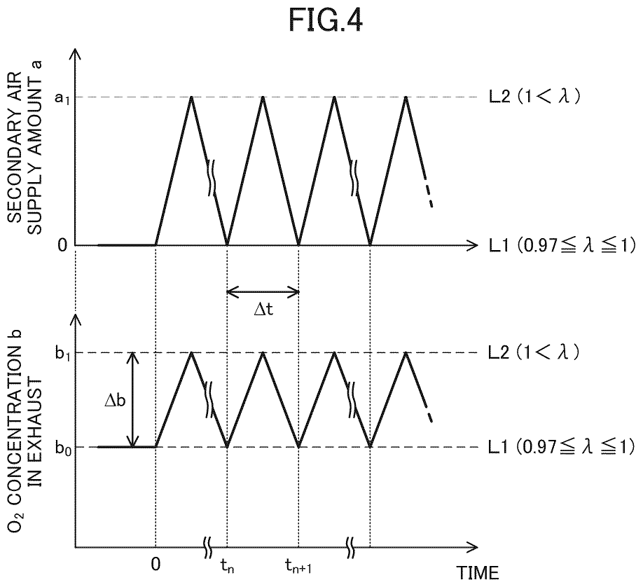

FIG. 4 is a conceptual diagram for explaining the periodicity of the secondary air.

When periodicity is imparted to the secondary air, the temporal variation in the secondary air supply amount a is such that the secondary air supply amount a periodically varies between 0 (zero) and a₁, as shown in FIG. 4, where a₁ is the maximum secondary air supply amount. Further, with the variation of the secondary air supply amount a, the oxygen concentration b after the secondary air supply also periodically varies, as shown in the lower side of FIG. 4. That is, where the oxygen concentration in the exhaust before the secondary air supply is b₀, and the maximum oxygen concentration in the exhaust after the secondary air supply is b₁, the oxygen concentration periodically varies between b₀ and b₁.

For example, when the air-fuel ratio of the exhaust before the secondary air supply is in the non-lean state L1 of λ≤1 (specifically, for example, in a stoichiometric or weak rich state of 0.97≤λ≤1), the periodic variation of the secondary air supply amount causes periodic variation of the air-fuel ratio of the exhaust after the secondary air supply between the non-lean state L1 and the lean state L2 (1<2).

Where the time required for one cycle from a time tₙ, at which the secondary air supply amount is 0, to a time tₙ₊₁, at which the secondary air supply amount returns to 0 after reaching the maximum supply amount a₁, is Δt=tₙ₊₁−tₙ, the temporal variation in the secondary air supply amount is such that the secondary air supply amount periodically varies at a frequency 1/Δt. Note that the temporal variation in the oxygen concentration of the exhaust after the secondary air supply is also such that the oxygen concentration periodically varies between b₀ and b₁ at generally the same frequency 1/Δt as the temporal variation in the secondary air supply amount. The frequency 1/Δt at which the secondary air supply amount a and the oxygen concentration b vary over time is simply referred to as “secondary air frequency” or merely “frequency” in this specification. The amplitude of the temporal variation in the oxygen concentration b in the exhaust after the secondary air supply, that is, the maximum increase Δb=b₁−b₀, is simply referred to as “secondary air amplitude” or merely “amplitude” in this specification.

Note that, in FIG. 4, the waveforms of the temporal variation in the secondary air supply amount and the oxygen concentration are shown in triangular waves, but this is only an example. The waveform of the temporal variation is not limited to a triangular wave, and may be a general waveform such as a sine wave, a square wave, or a rectangular wave. In the case of a rectangular wave, a secondary air stopping time during which the secondary air supply amount becomes 0 and a secondary air supplying time during which the secondary air supply amount becomes the maximum supply amount a₁ are alternately repeated. As described above, the periodicity of the secondary air may be such that an interval is provided between secondary air supply times. Such a mode of periodicity can be set by control signals output from the ECU 100 to the secondary air supply pump 41, the secondary air control valve 42, and the like.

### [Amplitude and Frequency of Secondary Air Supply]

The amplitude Ab and the frequency 1/Δt of the secondary air are adjusted by a change in the discharge amount of the secondary air supply pump 41 and by a change rate in an opening degree of the secondary air control valve 42. The amplitude and the frequency may be kept constant or may be varied.

From the viewpoint of improving the purification performance of the fourth catalyst 36 by generating a cycle of the adsorption heat and the oxidation heat in the fourth catalyst 36 at a favorable balance, the amplitude Ab and the frequency 1/Δt of the secondary air may be such that the amplitude is more than 0.50% and 3.0% or less, when the frequency of the secondary air is a fixed value more than 0 Hz and 1.5 Hz or less. Further, when the frequency of the secondary air is a fixed value more than 0 Hz and 0.5 Hz or less, the amplitude may be more than 0.50% and 3.0% or less.

Further, from the viewpoint of improving purification performance for HC and CO, the amplitude of the secondary air may be more than 0.66% and 3.0% or less, and may further be 0.78% or more and 1.8% or less.

From the viewpoint of improving the purification performance of the fourth catalyst 36 by generating a cycle of the adsorption heat and the oxidation heat in the fourth catalyst 36 at a favorable balance, the amplitude Ab and the frequency 1/Δt of the secondary air may be such that the frequency is more than 0 Hz and 1.5 Hz or less, when the amplitude is a fixed value more than 0% and 3.0% or less.

From the viewpoint of improving the purification performance for HC, the frequency of the secondary air may be 0.20 Hz or more and 0.94 Hz or less, or may be 1.20 Hz or more and 1.25 Hz or less. Further, from the viewpoint of improving the purification performance for HC and CO, the frequency of the secondary air may be more than 0.25 Hz and less than 0.82 Hz.

Note that the amplitude Ab and the frequency 1/Δt of the secondary air may differ between a set value by the ECU 100 and a measured value calculated from a detected value by an exhaust sensor or the like. The above numerical range of the amplitude and the frequency of the secondary air may be based on either the set value or the measured value, but are preferably based on the measured value.

### Experimental Example A

### [Sample Preparation]

A catalytic layer shown in Table 1 was provided on a carrier formed of a flow-through-type substrate (25.4 mm in diameter×25 mm in length, 25 mL in volume) made of cordierite, and catalyst samples of Experimental Examples A1 and A2 were thus prepared.

TABLE 1

| | | | Amount Supported [g/L] | |
|---|---|---|---|---|
| | | | Experimental | Experimental |
| | Material | | Example A1 | Example A2 |
| Zeolite | Ion-Exchanged Cu | Si/Al Ratio: 20 to 40 | 230 | — |
| | CHA-Type Zeolite | Cu Concentration: | | |
| | (Small-Pore Zeolite) | 2 mass % to 4 mass % | | |
| | BEA-Type Zeolite | Si/Al Ratio: 20 to 40 | — | 50 |
| | (Large-Pore Zeolite) | | | |

| | | | |
|---|---|---|---|
| Binder | Alumina | 25 | 5 |

Commercial products were used as the zeolite and the binder. The zeolite shown in Table 1, the binder, and ion-exchanged water were mixed to form slurry, and the slurry was applied to coat the entire length of the carrier. After drying, the product was fired in the air at 450° C. for two hours to obtain a catalyst sample.

### [Evaluation Conditions]

The catalyst samples of Experimental examples A1 and A2 were mounted in a gas flow reactor. Then, as a pre-treatment, a simulated gas having a composition of 10% H₂O and the remainder N₂ was supplied at a flow rate of 15 L/min, and the gas temperature was increased from 100° C. to 500° C. at a temperature rise rate of 30° C./min, followed by cooling from 500° C. to 100° C. at a temperature drop rate of 30° C./min in the same simulated gas. Next, as part of this evaluation (adsorption), a simulated gas with a composition of 500 ppm NH₃, 500 ppm C-nC₈H₁₈, 10% H₂O, and the remainder N₂ was supplied at a flow rate of 15 L/min, and the gas temperature was maintained at 100° C. for 30 minutes. After that, as this evaluation (desorption), the temperature was raised from 100° C. to 500° C. in N₂ at a temperature rise rate of 30° C./min), and the concentrations of NH₃ and HC on a downstream side (outlet) of the catalyst sample were measured.

### [Evaluation Results]

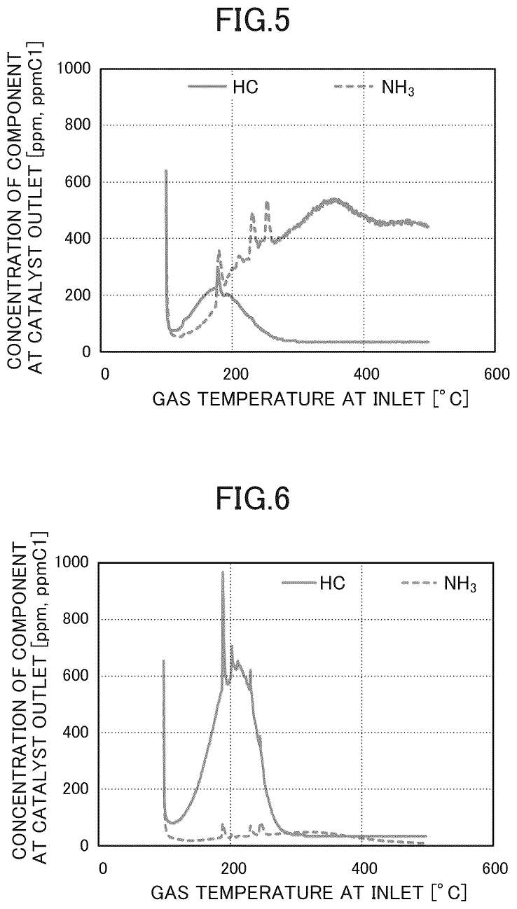

FIGS. 5 and 6 show relationships between gas temperatures at the upstream sides (inlets) of the catalyst samples and component concentrations at catalyst outlets in Experimental Examples A1 and A2.

As shown in FIG. 5, in Experimental Example A1 using the small pore zeolite, the concentration of the NH₃ increased with an increase in the gas temperature. Further, the concentration of HC was lower than that of the NH₃ as a whole. From this result, it is found in this evaluation (adsorption) that the small pore zeolite mainly adsorbed NH₃.

On the other hand, in Experimental Example A2 using the large pore zeolite, the concentration of HC was high, while the concentration of NH₃ was low, as shown in FIG. 6. From this result, it is found in this evaluation (adsorption) that the large pore zeolite mainly adsorbed HC.

### Experimental Example B

### —Sample Preparation—

A catalytic layer of the second catalyst 34 shown in Table 2 was provided on a carrier formed of a flow-through-type substrate (25.4 mm in diameter×25 mm in length, 25 mL in volume) made of cordierite, and a catalyst sample of the second catalyst 34 was thus prepared.

Further, a catalytic layer of the fourth catalyst 36 shown in Table 2 was provided on a carrier formed of a flow-through-type substrate (25.4 mm in diameter×25 mm in length, 25 mL in volume) made of cordierite, and a catalyst sample of the fourth catalyst 36 was thus prepared.

TABLE 2

| | | | | Amount Supported |
|---|---|---|---|---|
| | Material | | | [g/L] |
| Second | Zeolite | Ion-Exchanged Cu | Si/Al Ratio: 20 to 40 | 230 |
| Catalyst | | CHA-Type Zeolite | Cu Concentration: | |
| 34 | | (Small-Pore Zeolite) | 2 mass % to 4 mass % | |
| | Binder | Alumina | | 25 |
| Fourth | Pd | Pd | | 3 |
| Catalyst | Supported | CeZrNdOx | CeO₂:ZrO₂:Nd₂O₃ = | 97 |
| 36 | CeZrNdOx | | 10:80:10 [Mass Ratio] | |

| | | |
|---|---|---|
| Binder | Y-Stabilized Zirconia | 10 |

Commercial products were used as the zeolite, Pd (palladium nitrate) and the binder. The CeZr-based composite oxide (CeZrNdOx) was prepared by a general coprecipitation method. The support of Pd on the CeZr-based composite oxide was carried out by evaporation to dryness using an aqueous palladium nitrate solution. Both the second catalyst 34 and the fourth catalyst 36 were each mixed with the materials, binder shown in Table 2, and ion-exchanged water to form slurry, and this slurry was applied to coat the entire length of the carrier. After drying, the product was fired in the air at 450° C. for two hours to obtain a catalyst sample.

### [Evaluation Conditions]

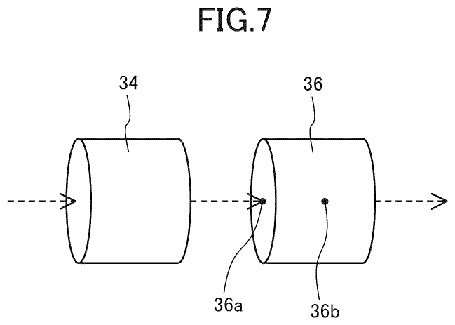

As shown in FIG. 7, the catalyst sample of the second catalyst 34 and the catalyst sample of the fourth catalyst 36 were mounted in the gas flow reactor in this order. Then, an evaluation was conducted under three conditions of Experimental Examples B1 to B3 shown in Table 3.

TABLE 3

| | | | | Gas Flow | Gas | Temperature | Retention |
|---|---|---|---|---|---|---|---|
| | | | | Rate | Temperature | Rise Rate | Time |
| Experimental Examples | | Step | Gas Composition | [L/min] | [° C.] at Inlet | [° C./min] | [Min] |
| B1 | Steady O₂ Supply | Adsorption | 500 ppm-NH₃/10%-H₂O/1%-O₂/Remainder N₂ | 15 | 100 | — | 30 |
| | [Lower NH₃ Adsorption] | Oxidation | | | 100 → 500 | 30 | — |
| B2 | Steady O₂ Supply | Adsorption | 500 ppm-NH₃/10%-H₂O/1%-O₂/Remainder N₂ | 15 | 100 | — | 60 |
| | [Higher NH₃ Adsorption] | Oxidation | | | 100 → 500 | 30 | — |
| B3 | Periodic O₂ Supply | Adsorption | 500 ppm-NH₃/10%-H₂O/1%-O₂/Remainder N₂ | 15 | 100 | — | 60 |
| | [Higher NH₃ Adsorption] | Oxidation | 500 ppm-NH₃/10%-H₂O/0.5%-O₂ + Simulated | | 100 → 500 | 30 | — |
| | | | Secondary Air (Frequency: 0.5 Hz, | | | | |
| | | | Amplitude: 1%-O₂) | | | | |

Specifically, as an adsorption step, a simulated gas having a composition of each experimental example shown in Table 3 was supplied from the upstream side at a predetermined flow rate and was maintained for a predetermined time at a predetermined inlet gas temperature. After that, as an oxidation step, the gas temperature at inlet was raised from 100° C. to 500° C. at the temperature rise rate shown in Table 3. Note that, in Experimental Example B3, additional oxygen simulating the secondary air was supplied during the oxidation step at the frequency and amplitude shown in Table 3. Further, in the oxidation step, temperature changes at an inlet measurement point 36a and a central measurement point 36b (see FIG. 7) of the fourth catalyst 36 were measured.

### [Evaluation Results]

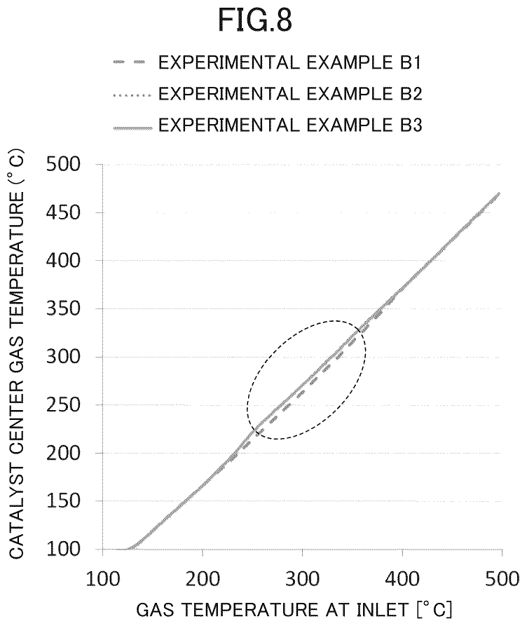

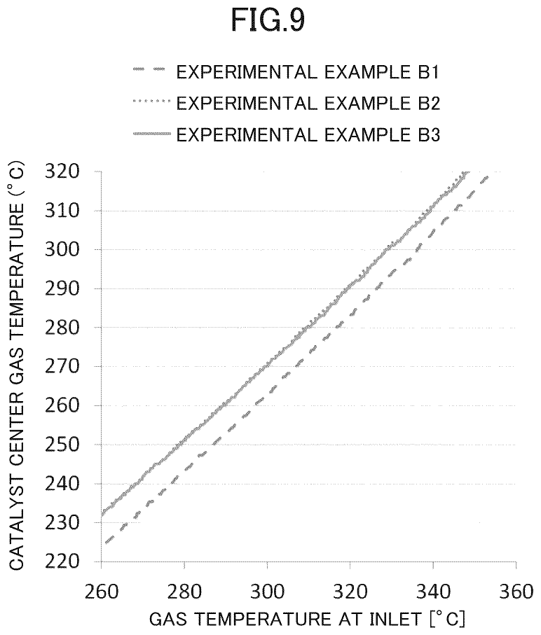

FIGS. 8 and 9 are diagrams in which temperatures at the central measurement point 36b (catalyst center gas temperatures) are plotted against temperatures at the inlet measurement point 36a (inlet gas temperatures) for each of Experimental Examples B1 to B3. FIG. 9 is an enlarged view of a portion encircled by a broken line in FIG. 8.

As shown in FIGS. 8 and 9, in Experimental Example B2, in which a large amount of NH₃ was adsorbed on the catalyst sample of the second catalyst 34 (with a long retention time of 60 minutes), an increase in the temperature at the central measurement point 36b was observed compared to Experimental Example B1, in which a smaller amount of NH₃ was adsorbed (with a short retention time of 30 minutes).

In Experimental Example B3, in which the simulated secondary air was periodically supplied to periodically vary the oxygen concentration between 0.5% and 1.5%, a temperature rise of a similar degree was observed compared to Experimental Example B2, in which the oxygen concentration was kept constant at 1%.

### Experimental Example C

Next, the following experiment was conducted to verify that periodically supplying the secondary air to the fourth catalyst 36 enables improvement in the catalytic activity.

The catalyst containing mixture of rhodium and palladium as precious metal particles; cerium-zirconium-based composite oxide and alumina as promoters; and zirconia as a binder was used. The material of the substrate was cordierite, and a flow-through-type substrate was used.

### [Evaluation Conditions]

The base gas consists of 0.77% of 02; 0.9% of CO; 400 ppm of NO; 600 ppm of C—C₃H₆; 100 ppm of C—C₂H₄; 800 ppm of C-normal C₈H₁₈; 10% of H₂O, and remainder N₂. The simulated gas for testing was obtained by adding O₂ as a simulated secondary air to the base gas, where the amplitude and frequency of O₂ were predetermined assuming the secondary air. The simulated gas was controlled so that the gas flows at a space velocity of 36,000 (l/h) and the temperature rises to 600° C. at a temperature rise rate of 30° C./min.

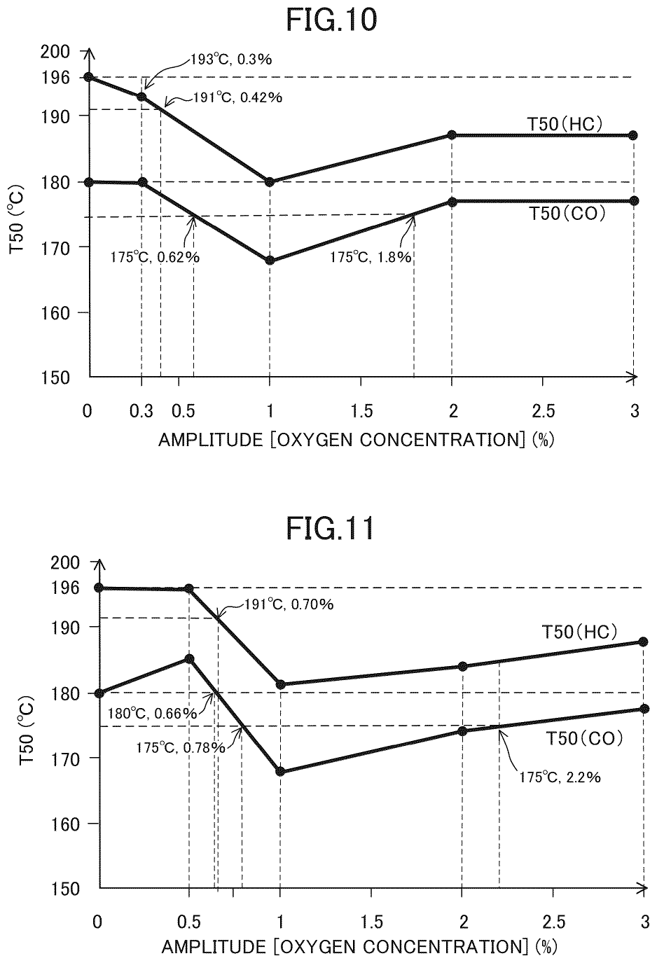

The gas temperatures (T50 (HC)) at the inlet of the catalyst when the HC purification rate reaches 50% and the gas temperatures (T50 (CO)) at the inlet of the catalyst when the CO purification rate reaches 50% are shown in FIGS. 10 to 13 and Tables 4 to 7.

TABLE 4

| Amplitude | | |
|---|---|---|
| (O₂ Concentration (%)) | HC-T50 (° C.) | CO-T50 (° C.) |
| 0 | 196 | 180 |
| 0.3 | 193 | 180 |
| 1 | 180 | 168 |
| 2 | 187 | 177 |
| 3 | 187 | 177 |

TABLE 5

| Amplitude | | |
|---|---|---|
| (O₂ Concentration (%)) | HC-T50 (° C.) | CO-T50 (° C.) |
| 0 | 196 | 180 |
| 0.5 | 196 | 185 |
| 1 | 181 | 168 |
| 2 | 184 | 174 |
| 3 | 188 | 177 |

TABLE 6

| Frequency (Hz) | HC-T50 (° C.) | CO-T50 (° C.) |
|---|---|---|
| 0 | 196 | 179 |
| 0.125 | 193 | 181 |
| 0.25 | 180 | 168 |
| 0.5 | 181 | 168 |
| 1 | 192 | 179 |
| 1.5 | 188 | 180 |

TABLE 7

| Frequency (Hz) | HC-T50 (° C.) | CO-T50 (° C.) |
|---|---|---|
| 0 | 196 | 179 |
| 0.25 | 189 | 179 |
| 0.5 | 184 | 174 |
| 1 | 190 | 181 |
| 1.5 | 192 | 182 |

### [Evaluation Result 1]

The results obtained when the frequency was fixed to 0.25 Hz and the amplitude was set to a predetermined value ranging from 0% to 3.0% are shown in FIG. 10 and Table 4. The graph and table show that when the amplitude was more than 0% and 3% or less, T50 (HC) was lower than when the simulated secondary air was not supplied (or lower than T50 (HC) obtained when the amplitude was 0%), which means that the catalytic activity with respect to HC was improved. The graph and table also show that when the amplitude was 0.42% or more, T50 (HC) was lower by 5° C. or more than when the simulated secondary air was not supplied (or lower than T50 (HC) obtained when the amplitude was 0%), which means that the activity was further improved within that range. The graph and table also show that when the amplitude was more than 0.30% and 3.0% or less, T50 (CO) was lower than when the simulated secondary air was not supplied (or lower than T50 (CO) obtained when the amplitude was 0%), which means that the catalytic activity with respect to CO was improved. The graph and table also show that when the amplitude was 0.62% or more and 1.8% or less, T50 (CO) was lower by 5° C. or more than when the simulated secondary air was not supplied (or lower than T50 (CO) obtained when the amplitude was 0%), which means that the activity was further improved within that range.

### [Evaluation Result 2]

The results obtained when the frequency was fixed to 0.5 Hz and the amplitude was set to a predetermined value ranging from 0% to 3.0% are shown in FIG. 11 and Table 5. According to FIG. 11, the graph and table show that when the amplitude was more than 0.50% and 3.0% or less, T50 (HC) was lower than T50 (HC) obtained when the amplitude was 0%, which means that the catalytic activity with respect to HC was improved. The graph and table also show that when the amplitude was 0.70% or more, T50 (HC) was lower by 5° C. or more than T50 (HC) obtained when the amplitude was 0%, which means that the activity was further improved within that range. The graph and table also show that when the amplitude was more than 0.66% and 3.0% or less, T50 (CO) was lower than T50 (CO) obtained when the amplitude was 0%, which means that the catalytic activity with respect to CO was improved. The graph and table also show that when the amplitude was 0.78% or more and 2.2% or less, T50 (CO) was lower by 5° C. or more than T50 (CO) obtained when the amplitude was 0%, which means that the activity was further improved within that range.

Evaluation Results 1 and 2 reveal more appropriate ranges of the amplitude of the secondary air. When the frequency was fixed to a value more than 0 Hz and 1.5 Hz or less, increasing the amplitude to more than 0.50% makes it possible to lower at least T50 (HC). Employing the amplitude of more than 0.66% makes it possible to reduce both T50 (HC) and T50 (CO). Employing the amplitude of 0.7% or more makes it possible to reduce T50 (HC) by 5° C. or more, thereby significantly improving the HC purification performance. Employing the amplitude of 0.78% or more and 1.8% or less makes it possible to reduce T50 (HC) and T50 (CO) by 5° C. or more, thereby significantly improving the HC and CO purification performance.

### [Evaluation Result 3]

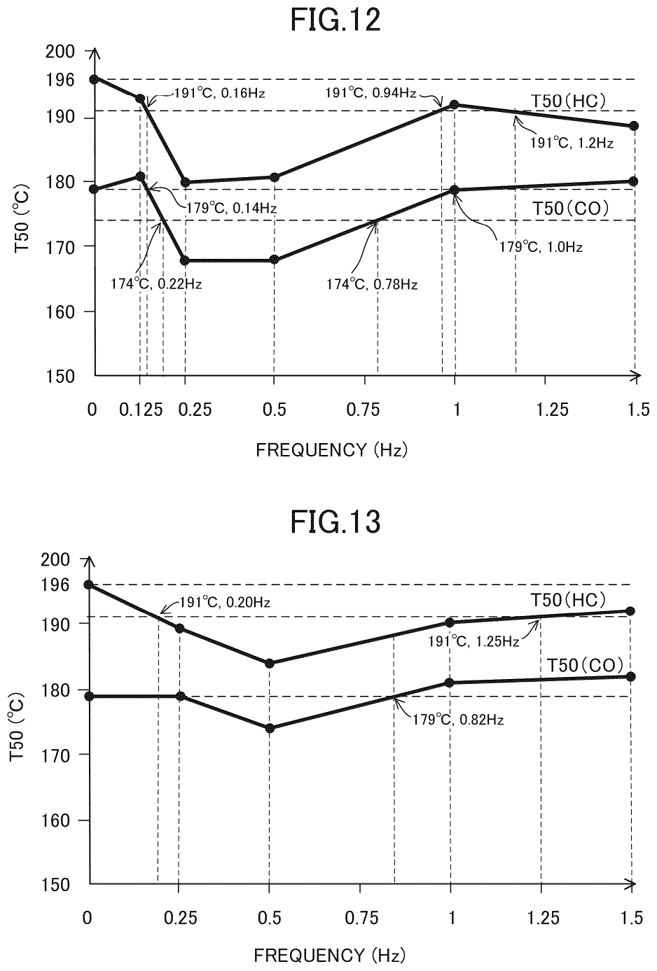

The results obtained when the amplitude was fixed to 1.0% and the frequency was set to a predetermined value ranging from 0 Hz to 1.5 Hz are shown in FIG. 12 and Table 6. The graph and table show that when the frequency was more than 0 Hz and 1.5 Hz or less, T50 (HC) was lower than T50 (HC) obtained when the frequency was 0 Hz, which means that the catalytic activity with respect to HC was improved. The graph and table also show that when the frequency was 0.16 Hz or more and 0.94 Hz or less or when the frequency was 1.2 Hz or more and 1.5 Hz or less, T50 (HC) was lower by 5° C. or more than T50 (HC) obtained when the frequency was 0 Hz, which means that the activity was further improved within that range. The graph and table also show that when the frequency was more than 0.14 Hz and 1.0 Hz or less, T50 (CO) was lower than T50 (CO) obtained when the frequency was 0 Hz, which means that the catalytic activity with respect to CO was improved. The graph and table also show that when the frequency was 0.22 Hz or more and 0.78 Hz or less, T50 (CO) was lower by 5° C. or more than T50 (CO) obtained when the frequency was 0 Hz, which means that the activity was further improved within that range.

### [Evaluation Result 4]

The results obtained when the amplitude was fixed to 2.0% and the frequency was set to a predetermined value ranging from 0 Hz to 1.5 Hz are shown in FIG. 13 and Table 7. The graph and table show that when the frequency was more than 0 Hz and 1.5 Hz or less, T50 (HC) was lower than T50 (HC) obtained when the frequency was 0 Hz, which means that the catalytic activity with respect to HC was improved. The graph and table also show that when the frequency was 0.20 Hz or more and 1.25 Hz or less, T50 (HC) was lower by 5° C. or more than T50 (HC) obtained when the frequency was 0 Hz, which means that the activity was further improved within that range. The graph and table also show that when the frequency was more than 0.25 Hz and 0.82 Hz or less, T50 (CO) was lower than T50 (CO) obtained when the frequency was 0 Hz, which means that the catalytic activity with respect to CO was improved.

Evaluation Results 3 and 4 reveal more appropriate ranges of the frequency of the secondary air. When the amplitude was fixed to a value more than 0% and 3.0% or less, increasing the frequency to more than 0 Hz makes it possible to lower at least T50 (HC) and improve HC purification performance. Employing the frequency of 0.20 Hz or more and less than 0.94 Hz or 1.2 Hz or more and 1.25 Hz or less makes it possible to reduce at least T50 (HC) by 5° C. or more, thereby significantly improving the HC purification performance. Employing the frequency of 0.25 Hz or more and less than 0.82 Hz makes it possible to reduce T50 (HC) by 5° C. or more, as well as reduce T50 (CO), thereby improving the HC and CO purification performance.

### Second Embodiment

Now, other embodiments according to the present disclosure will be described in detail. In descriptions of these embodiments, the same parts as those of the first embodiment are denoted by the same reference characters, and detailed descriptions thereof are omitted.

The first catalyst 33 may contain Pt. Pt may be contained as part of the three-way catalyst in the first catalyst 33 or as a Pt catalyst separate from the three-way catalyst in the first catalyst 33.

Pt can promote NH₃ generating reaction of the above formula (1) and the like, and increase the amount of NH₃ generated. Specifically, when the concentrations of HC and CO increase in a rich atmosphere, a water gas reaction and a steam reforming reaction proceed, resulting in the generation of H₂. Pt has a function of promoting the water gas reaction and the steam reforming reaction, and increases the amount of H₂ generated. Thus, the amount of NH₃ generated is increased.

Since the first catalyst 33 includes a three-way catalyst, it is possible to promote generation of NH₃ in the first catalyst 33 by the first catalyst 33 containing Pt, while maintaining the performance as the three-way catalyst. Thus, the amount of oxidation heat generated in the fourth catalyst 36 is increased, further promoting the early temperature rise of the fourth catalyst 36, which is advantageous in enhancing the purification performance of the fourth catalyst 36.

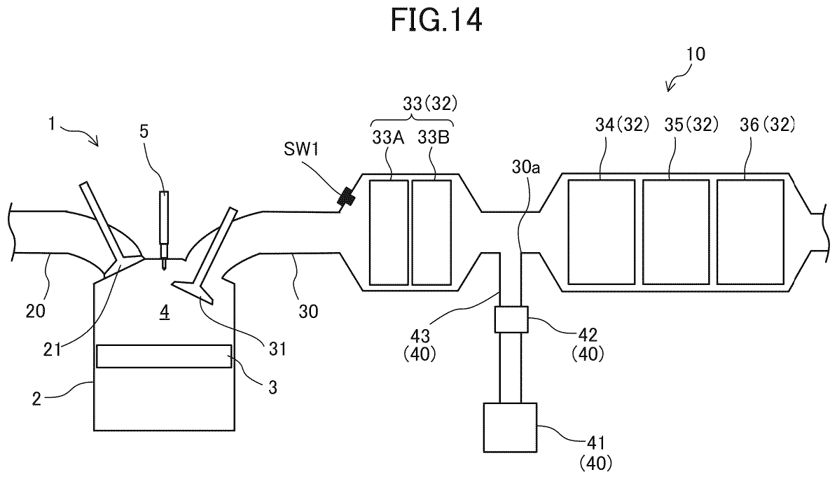

Specifically, for example, as shown in FIG. 14, the carrier of the first catalyst 33 may be segmented into two, and a catalytic layer of the three-way catalyst may be provided on a front portion 33A on the upstream side, while a catalytic layer of a Pt catalyst may be provided on a rear portion 33B on the downstream side (a region of the first catalyst on the downstream end side).

By arranging Pt in the rear portion 33B, the purification performance of the three-way catalyst can be sufficiently ensured in the front portion 33A of the first catalyst 33. Further, NH₃ can be proactively generated in the rear portion 33B of the first catalyst 33, which is advantageous in improving the purification performance of the fourth catalyst 36.

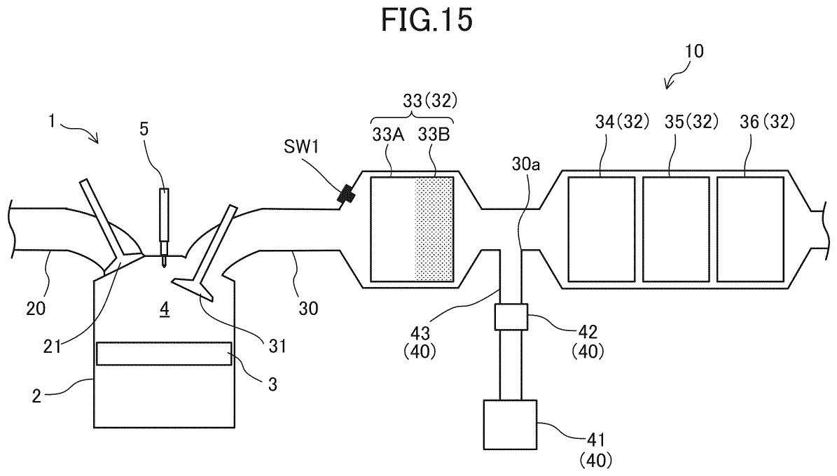

FIG. 14 shows a configuration in which the three-way catalyst and the Pt catalyst are separated. However, the present configuration is not limited to such a configuration. For example, as shown in FIG. 15, a zone-coat structure may be adopted in which a region on an upstream end side of a single carrier is set as a front portion 33A and a region on a downstream end side of the carrier is set as a rear portion 33B, and catalytic layers are applied separately.

In this case, the three-way catalyst may be configured to contain Pt, Rh, and Pd as noble metal catalysts. The front portion 33A may have a higher concentration of Rh and Pd (the amounts of Rh and Pd supported) than the concentration of Pt (the amount of Pt supported), and the rear portion 33B may have a higher concentration of Pt than the concentrations of Rh and Pd.

By making the front portion 33A rich in Rh and Pd, it is possible to sufficiently ensure the purification performance of the three-way catalyst in the front portion 33A. Further, by making the rear portion 33B rich in Pt, NH₃ can be proactively generated in the rear portion 33B, which is advantageous in improving the purification performance of the fourth catalyst 36.

Further, the present configuration is not limited to those shown in FIGS. 14 and 15. A catalytic layer having a multilayer structure may be provided on a single carrier, where one layer or some of the multiple layers may be a Pt-rich layer, and the remaining layers may be a three-way catalyst layer or a Rh- and Pd-rich layer. The ratio of the amount of Pt supported to the total amount of Rh, Pd, and Pt supported in the first catalyst 33 is not intended to be limited, but may be, for example, 20 mass % or more and 50 mass % or less in terms of metal. The mass ratio of Rh to Pd in the first catalyst 33 is not intended to be limited, but may be, for example, from 1:1 to 1:6 in terms of metal.

The ratio of the rear portion 33B to the total length of the front portion 33A and the rear portion 33B in the exhaust flow direction is not intended to be limited, but may be, for example, 25% or more and 60% or less.

### Experimental Example D

### [Sample Preparation]

A catalytic layer shown in Table 8 was provided on a carrier formed of a flow-through-type substrate (25.4 mm in diameter×25 mm in length) made of cordierite, and a TWC was thus produced. Further, a catalytic layer shown in Table 9 was provided on a carrier formed of a flow-through-type substrate (25.4 mm in diameter×25 mm in length) made of cordierite, and a Pt catalyst was thus produced. The total volume of the carrier for the TWC and Pt catalyst was 25 mL. These TWC and Pt catalyst were used as the catalyst samples of Experimental Example D1.

TABLE 8

| | | | Amount Supported |
|---|---|---|---|
| | First Catalyst (Upstream: TWC) | | [g/L] |
| Upper | Rh Supported | Rh | 0.84 |
| Catalytic | CeZrNdOx | CeZrNdOx | 90 |
| Layer | | $( \begin{matrix}{CeO}_{2} : {ZrO}_{2} : {Nd}_{2} {O}_{3} = \\ 10 : 80 : 10 [ Mass Ratio ]\end{matrix} )$ | |
| | Rh Supported | Rh | 0.16 |
| | ZrLaYOx | ZrLaYOx | 30 |
| | | $( \begin{matrix}{ZrO}_{2} : {LaO}_{2} : {Y}_{2} {O}_{3} = \\ 84 : 6 : 10 [ Mass Ratio ]\end{matrix} )$ | |
| | Barium Nitrate | | 10 |
| | Binder | Y-Stabilized Zirconia | 12.2 |
| Lower | Pd Supported | Pd | 3.3 |
| Catalytic | Alumina | La-Stabilized Alumina | 45 |
| Layer | Pd Supported | Pd | 0.7 |
| | CeZrNdOx | CeZrNdOx | 35 |
| | | $( \begin{matrix}{CeO}_{2} : {ZrO}_{2} : {Nd}_{2} {O}_{3} = \\ 10 : 80 : 10 [ Mass Ratio ]\end{matrix} )$ | |
| | Binder | Y-Stabilized Zirconia | 11.2 |

Total Amount of Noble Metal Supported: 5.0 g/L

TABLE 9

| | | | Amount |
|---|---|---|---|
| | | | Supported |
| | First Catalyst (Downstream: Pt Catalyst) | | [g/L] |
| Catalytic | Pt Supported | Pt | 3.0 |
| Layer | Alumina | La-Stabilized Alumina | 97 |
| | Binder | Y-Stabilized Zirconia | 10 |

Further, a catalytic layer shown in Table 8 was provided on a carrier formed of a flow-through-type substrate (25.4 mm in diameter×50 mm in length, and 25 mL in volume) made of cordierite, and a TWC was thus produced. The TWC was used as a catalyst sample of Experimental Example D2.

However, the total support amount of the catalyst material is the same between the catalyst sample of Experimental Example D1 and the catalyst sample of Experimental Example D2. Further, in Tables 8 and 9, the supported amounts of the noble metal catalysts (Rh, Pd, and Pt) and barium nitrate are indicated in terms of metal.

Note that commercial products were used as the noble metal catalyst (noble metal nitrate), barium nitrate, alumina, and binder. The CeZr-based composite oxide (CeZrNdOx) and the Zr-based composite oxide (ZrLaYOx) that does not contain Ce were prepared by a general coprecipitation method. The noble metal catalyst was supported on a support by the evaporation to dryness method using an aqueous solution of a nitrate of a noble metal.

The method for preparing the TWC is as follows. First, each catalyst material of a lower catalytic layer shown in Table 8, the binder, and the ion-exchanged water were mixed to form slurry, and the slurry was applied to coat the entire length of the carrier. After drying, the product was fired in the air at 450° C. for two hours to form a lower catalytic layer. Then, the catalyst materials of an upper catalytic layer shown in FIG. 8, the binder, and ion-exchanged water were mixed to form slurry, and the slurry was applied to coat the entire length of the carrier provided with the lower catalytic layer. After drying, the product was fired in the air at 450° C. for two hours to form an upper catalytic layer. Thus, a TWC was obtained.

The method for preparing the Pt catalyst is as follows. That is, each catalyst material of a catalytic layer shown in Table 9, the binder, and the ion-exchanged water were mixed to form slurry, and the slurry was applied to coat the entire length of the carrier. After drying, the product was fired in the air at 450° C. for two hours to obtain a Pt catalyst.

### [Evaluation Conditions]

For Experimental Example D1, the above-mentioned catalyst samples, namely the TWC and the Pt catalyst, were mounted in this order in the gas flow reactor, and a simulated gas for evaluation was introduced from the TWC side. For Experimental Example D2, the above-mentioned catalyst sample containing the TWC was mounted in the gas flow reactor, and a simulated gas for evaluation was introduced from the upstream side. The upstream side of the catalyst sample is also referred to as “inlet”, and the downstream side is also referred to as “outlet”. The composition, A/F, and λ of the simulated gas used for the evaluation are shown in Table 10. The component concentrations of the gas are indicated by volume ratios.

TABLE 10

| HC (ppmC) | | CO | O₂ | NO | H₂ | H₂O | | | |
|---|---|---|---|---|---|---|---|---|---|
| C₃H₆ | Toluene | (ppm) | (ppm) | (ppm) | (ppm) | (%) | N₂ | A/F | λ |
| 300 | 400 | 7300 | 4000 | 1900 | 3200 | 10 | Remainder | 14.61 | 0.99 |

However, A/F was calculated based on the following equation (2). Further, λ was calculated by dividing the value of A/F by the stoichiometric air-fuel ratio 14.7 of the gasoline engine.

$$A / F = ( 14.7 \times 21 ) / ( 21 - ( {O}_{2} concentration - 3 / 2 \times HC concentration - 1 / 2 \times CO concentration + 1 / 2 \times NO concentration - 1 / 2 \times {H}_{2} concentration ) / 10000 ) \qquad ( 2 )$$

In the equation (2), “21” represents the oxygen concentration [vol %] in the air, and the values of the O₂ concentration [ppm], the HC concentration [ppmC], the CO concentration [ppm], the NO concentration [ppm], and the H₂ concentration [ppm] are as shown in Table 10. In the above equation (2), the A/F is calculated based on the concentrations of the respective components of the exhaust, taking into account the excess or deficiency of O₂ with respect to the oxidation reactions of HC, CO, and H₂, and the reduction reaction of NO, which are represented by the following reaction equations (3) to (6).

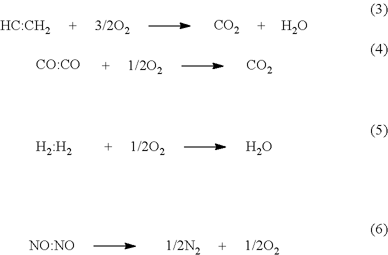

Note, however, that in the above HC reaction equation, the average C/H ratio of the HC component is assumed to be ½.

The flow rate of the simulated gas was set to 15.0 L/min (the space velocity of 11,000 h⁻¹), and the temperature was controlled to rise from 100° C. to 600° C. at a temperature rise rate of 30° C./min. The NH₃ concentration in the gas at the outlet was measured.

### [Evaluation Results]

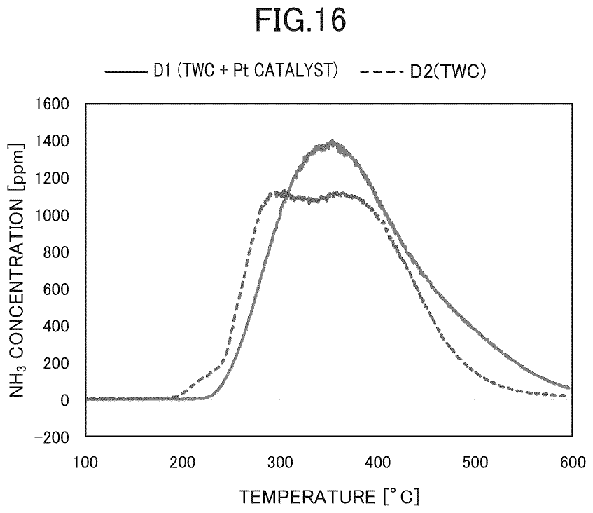

The evaluation results of Experimental Examples D1 and D2 are shown in FIG. 16. As shown in FIG. 16, it was found that, compared to Experimental Example D2 in which only the TWC was provided, Experimental Example D1 in which a Pt catalyst was provided subsequent to the TWC exhibited a higher NH₃ concentration at the outlet and a greater amount of NH₃ produced.

The present disclosure is significantly useful in the field of exhaust purification device.

What is claimed is:

1. An exhaust purification device, comprising:
a first catalyst arranged in an exhaust passage of an engine and containing a three-way catalyst;
a second catalyst arranged on a downstream side of the first catalyst in the exhaust passage and containing an NH₃ adsorbent;
a third catalyst arranged on a downstream side of the second catalyst in the exhaust passage and containing an HC adsorbent;
a fourth catalyst arranged on a downstream side of the third catalyst in the exhaust passage and containing an oxidation catalyst and an oxygen storage/release material; and
a secondary air supply device configured to supply secondary air between the first catalyst and the second catalyst in the exhaust passage, wherein
the NH₃ adsorbent includes a zeolite having a pore structure of an oxygen ring of less than 10 members, and
the HC adsorbent includes a zeolite having a pore structure of an oxygen ring of 10 members or more.

2. The exhaust purification device of claim 1, wherein
the zeolite having the pore structure of an oxygen ring of less than 10 members is a small pore zeolite having a pore structure of an 8-membered oxygen ring.

3. The exhaust purification device of claim 2, wherein
the small pore zeolite is a CHA-type zeolite containing Cu.

4. The exhaust purification device of claim 1, wherein
the zeolite having the pore structure of an oxygen ring of 10 members or more is a large-pore zeolite having a pore structure of a 12-membered oxygen ring.

5. The exhaust purification device of claim 4, wherein
the large pore zeolite is a BEA-type zeolite.

6. The exhaust purification device of claim 1, wherein
the secondary air is supplied when a temperature of the first catalyst is equal to or lower than a predetermined temperature.

7. The exhaust purification device of claim 6, wherein
a secondary air supply amount periodically varies.

8. The exhaust purification device of claim 1, wherein
the fourth catalyst contains, as the oxidation catalyst, a noble metal catalyst supported on the oxygen storage/release material.

9. The exhaust purification device of claim 1, wherein
the first catalyst contains Pt.

10. The exhaust purification device of claim 9, wherein
the Pt is arranged in a region of the first catalyst on a downstream end side.

11. The exhaust purification device of claim 9, wherein
the three-way catalyst contains the Pt, Rh, and Pd as noble metal catalysts,
a region of the first catalyst on an upstream end side has higher concentrations of the Rh and Pd than the concentration of the Pt, and
a region of the first catalyst on the downstream end side has higher concentration of the Pt than the concentrations of the Rh and Pd.
